(19) United States
(12) Patent Application Publication
(10) Pub. No.: US 2025/0255209 A1
(43) Pub. Date: Aug. 14, 2025

(54) WING FORCE MANAGEMENT SYSTEM FOR AN AGRICULTURAL IMPLEMENT

(71) Applicant: CNH Industrial America LLC, New Holland, PA (US)

(72) Inventors: Timothy Richard Blunier, Danvers, IL (US); Heath A. Toennies, Eureka, IL (US); Sven Nathaniel Setterdahl, Maquon, IL (US)

(21) Appl. No.: 18/439,079

(22) Filed: Feb. 12, 2024

(51) Int. Cl. A01B 73/04; F15B 13/04

(52) U.S. Cl. CPC A01B 73/044; F15B 13/0401

(57) ABSTRACT

A wing force management system of an agricultural implement includes a hydromechanical linkage assembly coupled to a frame of the agricultural implement. The hydromechanical linkage assembly includes a blocking valve fluidly coupled to a valve assembly. The valve assembly may control a wing fold cylinder of the agricultural implement, which may drive a wing section of the frame to rotate relative to a center section of the frame. A driver coupled to the frame of the agricultural implement may actuate the blocking valve in response to rotation of the wing section to control the valve assembly to adjust fluid pressure within the wing fold assembly.

### BACKGROUND

The present disclosure relates generally to a wing force management system for an agricultural implement.

Certain agricultural implements include ground engaging tools configured to interact with soil. For example, a tillage implement may include disc blades configured to break up the soil for subsequent planting or seeding operations. Groups of disc blades may be arranged in gangs, and each gang of disc blades may be rotatably coupled to a frame of the tillage implement. In certain tillage implements, the frame may include wing sections that may rotate between a working position and a transport position. Hydraulic cylinders may drive the wing sections to rotate between the working position (e.g., lowered position) and the transport position (e.g., raised position). Penetration depths of the disc blades on each wing section may be limited by the mass of the wing section.

### SUMMARY OF THE INVENTION

In certain embodiments, a wing force management system of an agricultural implement may include a hydromechanical linkage assembly coupled to a frame of the agricultural implement. The hydromechanical linkage assembly may include a blocking valve fluidly coupled to a valve assembly. The valve assembly may control a wing fold cylinder of the agricultural implement, which may drive a wing section of the frame to rotate relative to a center section of the frame. When the wing section rotates, a driver coupled to the frame of the agricultural implement may actuate the blocking valve to adjust fluid pressure within the wing fold assembly.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having a wing force management system;

FIG. 2 is a schematic view of an embodiment of a wing force management system that may be employed within the agricultural implement of FIG. 1; and

FIG. 3 is a schematic diagram of an embodiment of a hydraulic circuit that may be employed within the wing force management system of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

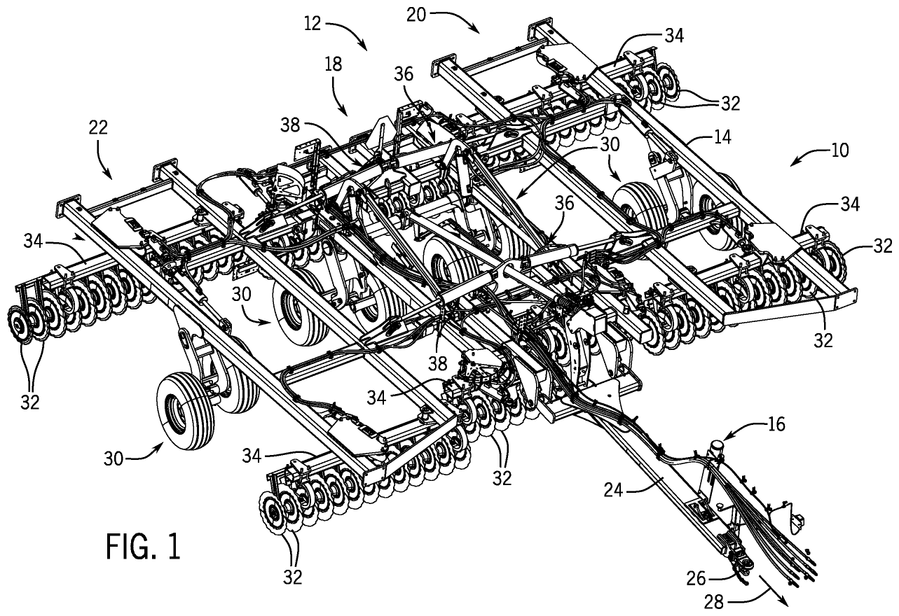

FIG. 1 is a perspective view of an embodiment of an agricultural implement 10 (e.g., tillage implement) having a wing force management system 12. In the illustrated embodiment, the tillage implement 10 is a vertical tillage implement having multiple ground engaging tools configured to till soil. As illustrated, the tillage implement 10 includes a frame 14 and a hitch assembly 16 coupled to the frame 14. The frame 14 may be formed from multiple frame elements (e.g., rails, tubes, braces, etc.) coupled to one another (e.g., via welded connection(s), via fastener(s), etc.). In the illustrated embodiment, the frame 14 includes a center section 18, a left wing section 20, and a right wing section 22. Each wing section is configured to rotate upwardly from the illustrated working position to a transport position to facilitate transport of the tillage implement 10. As discussed in detail below, actuators (e.g., hydraulic cylinders, etc.) are configured to drive the wing sections to rotate between the illustrated working position and the transport position.

In the illustrated embodiment, the hitch assembly 16 includes a hitch frame 24 and a hitch 26. The hitch frame 24 is pivotally coupled to the implement frame 14 via pivot joint(s), and the hitch 26 is configured to couple to a corresponding hitch of a work vehicle (e.g., tractor), which is configured to tow the tillage implement 10 through a field along a direction of travel 28. While the hitch frame 24 is pivotally coupled to the implement frame 14 in the illustrated embodiment, in other embodiments, the hitch frame may be movably coupled to the implement frame by a linkage assembly (e.g., four bar linkage assembly, etc.) or another suitable assembly/mechanism that enables the hitch to move along a vertical axis relative to the implement frame, or the hitch frame may be rigidly coupled to the implement frame.

As illustrated, the tillage implement 10 includes wheel assemblies 30 movably coupled to the implement frame 14. In the illustrated embodiment, each wheel assembly 30 includes a wheel frame and a wheel rotatably coupled to the wheel frame. The wheels of the wheel assemblies 30 are configured to engage the surface of the soil, and the wheel assemblies 30 are configured to support at least a portion of the weight of the tillage implement 10. In the illustrated embodiment, each wheel frame is pivotally coupled to the implement frame 14, thereby facilitating adjustment of the vertical position of the respective wheel(s). However, in other embodiments, at least one wheel frame may be movably coupled to the implement frame by another suitable connection (e.g., sliding connection, linkage assembly, etc.) that facilitates adjustment of the vertical position of the respective wheel(s).

In the illustrated embodiment, the tillage implement 10 includes disc blades 32 configured to engage a top layer of the soil. As the tillage implement 10 is towed through the field, the disc blades 32 are driven to rotate, thereby breaking up the top layer of the soil. In the illustrated embodiment, the disc blades 32 are arranged in two rows. However, in other embodiments, the disc blades may be arranged in more or fewer rows (e.g., 1, 3, 4, 5, 6, or more). Furthermore, in the illustrated embodiment, each row of disc blades 32 includes four gangs of disc blades 32. Two gangs of disc blades of the front row are coupled to the center section 18, two gangs of disc blades of the rear row are coupled to the center section 18, one gang of disc blades of the front row is coupled to the left wing section 20, one gang of disc blades of the rear row is coupled to the left wing section 20, one gang of disc blades of the front row is coupled to the right wing section 22, and one gang of disc blades of the rear row is coupled to the right wing section 22. While the tillage implement 10 includes eight gangs of disc blades 32 in the illustrated embodiment, in other embodiments, the tillage implement may include more or fewer gangs of disc blades (e.g., 2, 4, 6, 10, or more). Furthermore, the gangs of disc blades may be arranged in any suitable configuration on the implement frame.

The disc blades 32 of each gang are non-rotatably coupled to one another by a respective shaft, such that the disc blades 32 of each gang rotate together. Each shaft is rotatably coupled to a respective disc blade support 34, which is configured to support the gang, including the shaft and the disc blades 32. Furthermore, each disc blade support 34 is pivotally coupled to the frame 14 at a respective pivot point, thereby enabling the disc blade support 34 to rotate relative to the frame 14. Rotating the disc blade support 34 relative to the frame 14 controls the angle between the respective disc blades 32 and the direction of travel 28, thereby controlling the interaction of the disc blades 32 with the top layer of the soil. Each disc blade support 34 may include any suitable structure(s) configured to support the respective gang (e.g., including a square tube, a round tube, a bar, a truss, other suitable structure(s), or a combination thereof). While the disc blades 32 supported by each disc blade support 34 are arranged in a respective gang (e.g., non-rotatably coupled to one another by a respective shaft) in the illustrated embodiment, in other embodiments, at least a portion of the disc blades supported by at least one disc blade support (e.g., all of the disc blades supported by the disc blade support) may be arranged in another suitable configuration (e.g., individually mounted and independently rotatable, mounted in groups and individually rotatable, etc.). For example, in certain embodiments, a first portion of the disc blades supported by a disc blade support may be arranged in a gang, and a second portion of the disc blades supported by the disc blade support may be individually mounted and independently rotatable.

While the tillage implement includes the disc blades 32 in the illustrated embodiment, in other embodiments, the tillage implement may include other/additional ground engaging tool(s) (e.g., coupled to the disc blade support(s), coupled to the frame of the tillage implement, etc.). For example, in certain embodiments, the tillage implement may include tillage point assemblies (e.g., positioned behind the disc blades relative to the direction of travel) configured to engage the soil at a greater depth than the disc blades, thereby breaking up a lower layer of the soil. Each tillage point assembly may include a tillage point and a shank. The shank may position the tillage point at a target depth beneath the soil surface, and the tillage point may break up the soil. The shape of each tillage point, the arrangement of the tillage point assemblies, and the number of tillage point assemblies may be selected to control tillage within the field. Furthermore, in certain embodiments, the tillage implement may include finishing discs (e.g., positioned behind the disc blades relative to the direction of travel). In such embodiments, as the tillage implement is towed through the field, the finishing discs may be driven to rotate, thereby sizing soil clods, leveling the soil surface, smoothing the soil surface, cutting residue on the soil surface, or a combination thereof. In addition, in certain embodiments, the tillage implement may include one or more other/additional suitable ground engaging tools, such as coulter(s), opener(s), tine(s), finishing reel(s), other suitable ground engaging tool(s), or a combination thereof.

In the illustrated embodiment, the wing force management system 12 controls downforce applied to the left wing section 20 and to the right wing section 22 of the tillage implement 10 by wing fold cylinders. As discussed in detail below, the wing force management system 12 includes a hydromechanical linkage assembly coupled to the frame 14 of the tillage implement 10. The hydromechanical linkage assembly includes a blocking valve and a link. The blocking valve is part of a hydraulic circuit configured to control the wing fold cylinders. For example, the hydraulic circuit may control left wing fold cylinders 36 (e.g., one or more left wing fold cylinders) to rotate the left wing section 20, and the hydraulic circuit may control right wing fold cylinders 38 (e.g., one or more right wing fold cylinders) to rotate the right wing section 22. The link is configured to actuate the blocking valve to drive the blocking valve to change positions (e.g., open to closed). A driver mounted to a wing section of the frame 14 is configured to drive the link to actuate the blocking valve while the tillage implement 10 is transitioning from a transport configuration, in which the wing sections are in the transport position, to a working configuration, in which the wing sections are in the working position. In certain embodiments, the link may be omitted from the hydromechanical linkage assembly, and the driver may directly engage the blocking valve to actuate the blocking valve.

The hydromechanical linkage assembly may have a transport mode and an operation mode. The hydromechanical linkage assembly may change modes when a wing section is at a particular orientation between the working position and the transport position. In the transport mode, the blocking valve is closed, and fluid in a portion of the hydraulic circuit may not drain, which may generate and maintain a high pressure in the portion of the hydraulic circuit, thereby deactivating a pressure reducing valve. As a result, high pressure may be applied to the wing lift cylinders, thereby enabling the wing sections to rotate downwardly toward the working position in a short timeframe. With the wing sections in the folded transport position, the wings sections may be angled inwardly. The high pressure applied to the wing fold cylinders causes the wing fold cylinders to drive the wing sections to rotate toward the working position until the blocking valve opens. The blocking valve may be actuated after the wing sections go over-center, as the force of gravity may help rotate the wing sections to the working position after the wing sections go over-center. Accordingly, high pressure is no longer applied to the wing fold cylinders to drive the wing sections to the working position. In the operation mode, the blocking valve is open, and fluid in the portion of the hydraulic circuit may drain, thereby enabling the pressure reducing valve to limit pressure within the wing fold cylinders. Therefore, the wing fold cylinders may apply a relatively small force to the wing sections of the tillage implement 10 (e.g., relative to the force applied by the wing lift cylinders to drive the wing sections toward the working position), thereby increasing the penetration depths of the ground-engaging tools (e.g., disc blades 32). Limiting pressure within the wing fold cylinders in the operation mode may reduce compaction of the soil by the wheels while increasing the penetration depths of the ground-engaging tools. Accordingly, the wing force management system 12 may improve operation of the tillage implement 10 during transport and during tillage operations. While the wing force management system 12 is disclosed herein with regard to a tillage implement, the wing force management system may be employed within any suitable agricultural implement having rotatable wings, such as a planting implement, a seeding implement, a mowing implement, etc.

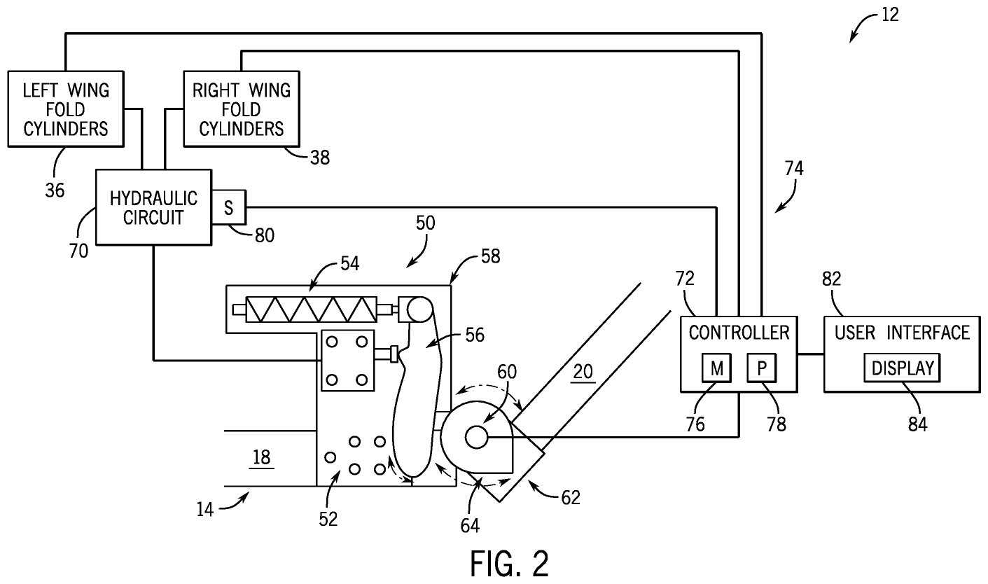

FIG. 2 is a schematic view of an embodiment of a wing force management system 12 that may be employed within the agricultural implement 10 of FIG. 1. The wing force management system 12 includes a hydromechanical linkage assembly 50 coupled to the frame 14 of the tillage implement 10. The hydromechanical linkage assembly 50 may be coupled to the frame 14 via any suitable type(s) of connection(s), such as a welded connection, a fastener connection, an adhesive connection, other suitable type(s) of connection(s), or a combination thereof. In the illustrated embodiment, the hydromechanical linkage assembly 50 is coupled to the center section 18 of the frame 14 via fasteners 52. While only one hydromechanical linkage assembly is illustrated in FIG. 2, the wing force management system 12 may include a left hydromechanical linkage assembly and a right hydromechanical linkage assembly. The left hydromechanical linkage assembly may be coupled to a left side of the center section 18 of the frame 14, in proximity to a pivot joint between the center section 18 and the left wing section. The right hydromechanical linkage assembly may be coupled to a right side of the center section 18, in proximity to a pivot joint between the center section 18 and the right wing section.

The hydromechanical linkage assembly 50 includes a blocking valve 54 and a link 56. The blocking valve 54 and the link 56 may be coupled to a housing 58, which may in turn be coupled to the frame 14 of the tillage implement 10 (e.g., via the fasteners 52). The housing 58 may be made out of any suitable material (sheet metal, hard plastic, etc.) and may be any suitable shape to accommodate the blocking valve 54 and the link 56. The housing 58 may protect the blocking valve 54 and the link 56 from debris (e.g., dirt, grass, etc.) and natural elements (rain, wind, etc.). While only one side of the housing 58 is shown in FIG. 2, the housing may include multiple sides, including a rear side and a front side.

The blocking valve 54 may be a normally closed, spring return valve. That is, the blocking valve 54 may be closed unless acted upon (e.g., given a mechanical input), and a spring may return the valve back to, or maintain, the normally closed position. The link 56 may engage the blocking valve 54 to drive the blocking valve 54 open. A driver 60 is coupled to a wing section of the frame 14 (e.g., left wing section 20) via a support 62 and is configured to drive the link 56 to actuate the blocking valve 54. For example, when the wing section of the frame 14 rotates downwardly from the folded transport position to the unfolded working position, the driver 60 may drive the link 56 to drive the blocking valve 54 to the open position. Conversely, when the wing section of the frame 14 rotates upwardly from the working position to the transport position, the driver 60 may stop driving the link 56 to actuate the blocking valve 54, thereby enabling the blocking valve to close. In certain embodiments, the link may be omitted and the driver may directly engage the blocking valve to actuate the blocking valve.

In the illustrated embodiment, the driver 60 includes a cam 64 that is configured to engage the link 56 while the wing section is at a particular orientation range between the transport position and the working position. This orientation range may be selected based on the configuration of the cam 64 and may depend on the use of the tillage implement 10. For example, if the wing section has a typical working range between 0 degrees and 15 degrees above horizontal (e.g., the wing section of the tillage implement is positioned at an angle between 0 and 15 degrees relative to a horizontal plane during tillage operations), the cam 64 may be configured to engage the link 56 while the wing section of the tillage implement is positioned approximately between 0 and 45 degrees above horizontal, between 0 and 30 degrees above horizontal, or between 0 and 15 degrees above horizontal. The maximum angle of the orientation range may be less than 90 degrees, so the cam does not engage the link until the wing sections go over-center, as the force of gravity may help rotate the wing sections to the working position after the wing sections go over-center.

In the present embodiment, when the cam 64 engages the link 56, the link 56 drives the blocking valve 54 open, such that the hydromechanical linkage assembly 50 is in the operation mode. Additionally, when the cam 64 does not engage (e.g., contact) the link 56, the link 56 does not actuate the blocking valve 54, such that the blocking valve 54 is closed, and the linkage assembly is in the transport mode. While the discussions herein have focused on a normally closed blocking valve 54, the blocking valve 54 may be a normally opened, spring return valve. In such embodiments, the cam 64 may engage the link 56 to drive the link 56 to drive the blocking valve 54 to the closed position. Therefore, in embodiments with a normally open blocking valve 54, when the cam 64 engages the link 56, the link 56 drives the blocking valve 54 to the closed position, such that the hydromechanical linkage assembly 50 is in the transport mode. Additionally, in embodiments with a normally open blocking valve 54, when the cam 64 does not engage the link 56, the link 56 does not actuate the blocking valve 54, such that the blocking valve 54 is open, and the hydromechanical linkage assembly 50 is in the operation mode.

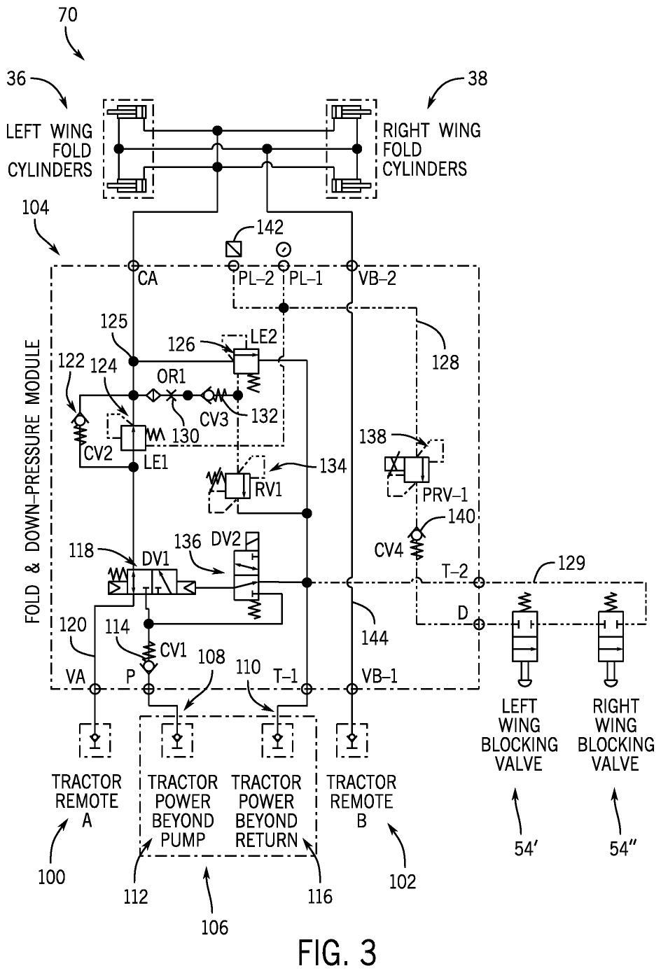

The blocking valve 54 is part of a hydraulic circuit 70. As discussed in detail below regarding FIG. 3, the hydraulic circuit 70 is fluidly coupled to the left wing fold cylinders 36 and to the right wing fold cylinders 38 of the tillage implement 10. The hydraulic circuit 70 may include a number of valves, and may control hydraulic fluid pressure within the left wing fold cylinders 36 and to the right wing fold cylinders 38 by controlling certain valves. In the illustrated embodiment, a controller 72 of a control system 74 is communicatively coupled to the hydraulic circuit 70 and is configured to output control signal(s) to certain valve(s) of the hydraulic circuit 70. For example, a valve in the hydraulic circuit 70 may be configured to adjust fluid pressure within the left wing fold cylinders 36 and within the right wing fold cylinders 38 to control the downforce applied by the wing fold cylinders while each wing section is in the working position based on output control signal(s) from the controller 72. Accordingly, the controller 72 is configured to control the left wing fold cylinders 36 and the right wing fold cylinders 38 via the hydraulic circuit 70.

In the transport mode, the blocking valve 54 is closed, and fluid in a portion of the hydraulic circuit 70 may not drain, which may generate and maintain a high pressure in the portion of the hydraulic circuit 70, thereby deactivating a pressure reducing valve. Therefore, the controller 72 may control the hydraulic circuit 70 to apply high pressure to the left wing fold cylinders 36 and the right wing fold cylinders 38, enabling the wing sections to rotate downwardly toward the working position in short timeframe. In the operation mode, the blocking valve 54 is open, and fluid in a portion of the hydraulic circuit 70 may drain, thereby enabling the pressure reducing valve to limit pressure within the left wing fold cylinders 36 and the right wing fold cylinders 38. Therefore, the controller 72 may control the hydraulic circuit 70 to apply relatively small force to the wing sections (e.g., relative to the force applied by the wing lift cylinders to drive the wing sections toward the working position), thereby increasing the penetration depths of the ground-engaging tools (e.g., disc blades). Limiting pressure within the wing fold cylinders in the operation mode may reduce compaction of the soil by the wheels while increasing the penetration depths of the ground-engaging tools.

The controller 72 is configured to control the left wing fold cylinders 36 and the right wing fold cylinders 38 to control the downforce applied by the ground-engaging tools (e.g., disc blades) while the tillage implement is in the working configuration. In certain embodiments, the controller 72 is an electronic controller having electrical circuitry configured to control the left wing fold cylinders 36 and the right wing fold cylinders 38 while the agricultural implement is in the working configuration. In the illustrated embodiment, the controller 72 includes a memory 76 and a processor 78. The controller 72 may also include one or more storage devices and/or other suitable components. The processor 78 may be used to execute software, such as software for controlling the left wing fold cylinders 36 and the right wing fold cylinders 38. Moreover, the processor 78 may include multiple microprocessors, one or more “general-purpose” microprocessors, one or more special-purpose microprocessors, and/or one or more application specific integrated circuits (ASICs), or some combination thereof. For example, the processor 78 may include one or more reduced instruction set (RISC) processors.

The memory 76 may include a volatile memory, such as random access memory (RAM), and/or a nonvolatile memory, such as read-only memory (ROM). The memory 76 may store a variety of information and may be used for various purposes. For example, the memory 76 may store processor-executable instructions (e.g., firmware or software) for the processor 78 to execute, such as instructions for controlling the left wing fold cylinders 36 and the right wing fold cylinders 38. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the left wing fold cylinders 36 and the right wing fold cylinders 38), and any other suitable data.

In some embodiments, the controller 72 may control the left wing fold cylinders 36 and the right wing fold cylinders 38 based on sensor feedback. For example, the hydraulic circuit 70 may include one or more sensors 80. The sensor(s) 80 may include a pressure sensor, a position sensor, a penetration depth sensor, and the like. For example, a pressure sensor may be fluidly coupled to the left wing fold cylinders 36 and to the right wing fold cylinders 38. The pressure sensor may output a signal indicative of a fluid pressure within the left wing fold cylinders 36 and within the right wing fold cylinders 38. Accordingly, the controller 72 may control the left wing fold cylinders 36 and the right wing fold cylinders 38 based on feedback from the pressure sensor to control the downforce applied by the wing fold cylinders while the tillage implement is in the working configuration.

Additionally and/or alternatively, a pressure sensor may be coupled to a fluid conduit of the hydraulic circuit 70 and may output a signal indicative of a pilot pressure within the hydraulic circuit 70. The pilot pressure may indicate whether the hydromechanical linkage assembly 50 is in the transport mode (e.g., associated with a high pilot pressure) or in the operation mode (e.g., associated with a low pilot pressure). Accordingly, the controller 72 may use pilot pressure sensor feedback to determine whether the hydromechanical linkage assembly 50 is in the transport mode or the operation mode.

Additionally and/or alternatively, a position sensor may be coupled to a left wing fold cylinder 36, to a right wing fold cylinder 38, to the left wing section 20, to the right wing section 22, to another suitable component of the tillage implement 10, or a combination thereof. The position sensor may output a signal indicative of the angular position of the left wing section 20 and/or the right wing section 22 relative to the center section 18. Accordingly, the controller 72 may determine the angular position(s) of the left wing section 20 and/or the right wing section 22 based on feedback from the position sensor(s).

Additionally and/or alternatively, a depth sensor may be coupled to any suitable component of the tillage implement (e.g., left wing section 20, right wing section, etc.), and the depth sensor may output a signal indicative of the penetration depth of the ground-engaging tools (e.g., disc blades). Accordingly, the controller 72 may control the hydraulic circuit 70 to adjust the downforce applied by the left wing fold cylinders 36 and the right wing fold cylinders 38 based on feedback from the depth sensor(s) to adjust the penetration depth of the ground-engaging tools.

In the illustrated embodiment, the control system 74 includes a user interface 82 communicatively coupled to the controller 72. The user interface 82 is configured to receive input from an operator and to provide information to the operator (e.g., hydraulic fluid pressure and/or flow, wing section position, etc.). The user interface 82 may include any suitable input device(s) for receiving input, such as a keyboard, a mouse, button(s), switch(es), knob(s), other suitable input device(s), or a combination thereof. In addition, the user interface 82 may include any suitable output device(s) for presenting information to the operator, such as speaker(s), indicator light(s), other suitable output device(s), or a combination thereof. In the illustrated embodiment, the user interface 82 includes a display 84 configured to present visual information to the operator (e.g., real time/near real time information, such as hydraulic fluid pressure and/or flow, wing section position, etc.). In certain embodiments, the display 84 may include a touchscreen interface configured to receive input from the operator (e.g., a capacitive touch screen with haptic feedback).

In certain embodiments, the user interface 82 is configured to receive input from the operator indicative of a command to increase or decrease the downforce applied by the left wing fold cylinders 36 and/or the right wing fold cylinders 38. The controller 72 is configured to control the left wing fold cylinders 36 and the right wing fold cylinders 38 based on the command. For example, in response to an indication on the user interface 82 that the penetration depth is less than a target penetration depth, the operator may provide an input to the user interface 82 indicative of increasing the downforce applied by the left wing fold cylinders 36 and/or the right wing fold cylinders 38.

FIG. 3 is a schematic diagram of an embodiment of a hydraulic circuit 70 that may be employed within the wing force management system of FIG. 2. The hydraulic circuit 70 is fluidly coupled to the left wing fold cylinders 36 and to the right wing fold cylinders 38 of the tillage implement. The hydraulic circuit 70 includes a first hydraulic fluid input 100 and a second hydraulic fluid input 102. The first hydraulic fluid input 100 is configured to provide hydraulic fluid for extension of the left wing fold cylinders 36 and the right wing fold cylinders 38. The second hydraulic fluid input 102 is configured to provide hydraulic fluid for retraction of the left wing fold cylinders 36 and the right wing fold cylinders 38. In certain embodiments, the controller of FIG. 2 may control the hydraulic fluid flow into the first and second hydraulic fluid inputs.

The second hydraulic fluid input 102 is directly fluidly coupled to the rod ends of the left wing fold cylinders 36 and the right wing fold cylinders 38. Accordingly, fluid may be provided to the second hydraulic fluid input 102 to directly control retraction of the wing fold cylinders, without intermediate valves. Furthermore, the first hydraulic fluid input 100 is fluidly coupled to the cap ends of the left wing fold cylinders 36 and the right wing fold cylinders 38 via a valve assembly 104. Therefore, when fluid is provided to the first hydraulic fluid input 100, the valve assembly 104 may control extension of the left wing fold cylinders 36 and the right wing fold cylinders 38. For example, the valve assembly 104 may control the fluid pressure within the cap ends of the left wing fold cylinders 36 and the right wing fold cylinders 38 to adjust the penetration depth of the ground-engaging tools. The valve assembly 104 is fluidly coupled to a left wing blocking valve 54′ and to a right wing blocking valve 54″. The hydromechanical linkage assembly 50 of FIG. 2 may include the left wing blocking valve 54′ and the right wing blocking valve 54″, each function as the blocking valve 54 disclosed above. When the left wing blocking valve 54′ or the right wing blocking valve 54″ is closed in the transport mode of the hydromechanical linkage assembly 50, the hydraulic fluid in a portion of the valve assembly 104 does not drain, thereby deactivating a pressure reducing valve. Accordingly, fluid applied to the first hydraulic fluid input 100 may directly flow to the cap ends of the wing fold cylinders, thereby enabling direct control of extension of the wing fold cylinders via the first hydraulic fluid input 100.

As depicted, the hydraulic circuit 70 is fluidly coupled to a hydraulic system 106 of a work vehicle (e.g., tractor) coupled to the tillage implement. The hydraulic system 106 of the work vehicle may provide pressurized hydraulic fluid to the hydraulic circuit 70 via a supply line 108 (e.g., high pressure supply line). Hydraulic fluid is returned to the hydraulic system 106 from the hydraulic circuit 70 via a return line 110 (e.g., a low pressure return line). In certain embodiments, there may be multiple supply lines 108 and/or multiple return lines 110 extending between the hydraulic circuit 70 and the hydraulic system 106 of the work vehicle.

The hydraulic system 106 includes a supply pump 112 located on the work vehicle. The supply pump 112 is configured to receive hydraulic fluid from a fluid source (e.g., tank) and to provide the fluid to the valve assembly 104 via the supply line 108. The valve assembly 104 includes a first check valve 114 in fluid communication with the supply line 108. The first check valve 114 is configured to enable flow of the hydraulic fluid from the supply pump 112 to downstream components of the valve assembly 104 and to block flow of the hydraulic fluid from the downstream components into the supply line 108. The hydraulic system 106 also includes a return 116 located on the work vehicle. The return 116 is configured to receive hydraulic fluid from the valve assembly 104 via the return line 110.

The valve assembly 104 also includes a first directional control valve 118, which is fluidly coupled to the supply line 108 via the first check valve 114. The first directional control valve 118 is a three-way, two-position directional control valve that is fluidly coupled to the supply line 108 and to a first control line 120, which is fluidly coupled to the first hydraulic fluid input 100. In a first position, the first directional control valve 118 enables hydraulic fluid to flow through the conduits between the first hydraulic fluid input 100 and the cap ends of the left wing fold cylinders 36 and the right wing fold cylinders 38. Furthermore, the valve assembly 104 includes a second check valve 122 fluidly coupled to the first directional control valve 118. The second check valve 122 is configured to enable hydraulic fluid flow from the cap ends of the left wing fold cylinders 36 and the right wing fold cylinders 38 to the first hydraulic fluid input 100 while the first directional control valve 118 is in the illustrated first position, thereby enabling hydraulic fluid from the cap ends of the left wing fold cylinders 36 and the right wing fold cylinders 38 to drain to the first hydraulic fluid input 100 while the wing fold cylinders are retracting. The second check valve 122 is also configured to block hydraulic fluid flow through the second check valve 122 while hydraulic fluid is supplied to the cap ends of the wing fold cylinders.

Furthermore, the valve assembly 104 includes a pressure reducing valve 124, which is fluidly coupled to the first directional control valve 118. The pressure reducing valve 124 is also fluidly coupled to the cap ends of the wing fold cylinders via a cap end conduit 125. The pressure reducing valve 124 is configured to selectively reduce the pressure of the hydraulic fluid supplied to the cap ends of the left wing fold cylinders 36 and the right wing fold cylinders 38, thereby controlling the downforce applied by the wing fold cylinders. In addition, the valve assembly 104 includes a first pressure relieving valve 126 fluidly coupled to the cap end conduit 125 at a location downstream from the pressure reducing valve 124. The first pressure relieving valve 126 is configured to direct hydraulic fluid from the cap end conduit 125 to the return line 110 in response to the fluid pressure within the cap end conduit 125 exceeding a maximum threshold pressure, thereby limiting the fluid pressure within the cap ends of the wing fold cylinders to the maximum threshold pressure. The maximum threshold pressure is controlled by fluid pressure within a pilot line 128 (represented as dashed a line in FIG. 3), which is fluidly coupled to the first pressure relieving valve 126. Control of the fluid pressure within the pilot line 128 is disclosed in detail below.

An orifice 130 and a third check valve 132 are disposed between the cap end conduit 125 and the pilot line 128. The orifice 130 is configured to regulate the flow of hydraulic fluid from the cap end conduit 125 to the pilot line 128, and the third check valve 132 is configured to enable fluid flow from the cap end conduit 125 to the pilot line 128 and to block fluid flow from the pilot line 128 to the cap end conduit 125. Accordingly, the pilot line 128 is provided with hydraulic fluid from the cap end conduit 125. A second pressure relieving valve 134 is fluidly coupled to the pilot line 128 and to the return line 110. The second pressure relieving valve 134 is configured to direct hydraulic fluid from the pilot line 128 to the return line 110 in response to the fluid pressure within the pilot line 128 exceeding a maximum pilot threshold pressure, thereby limiting the fluid pressure within the pilot line 128 to the maximum pilot threshold pressure.

In the illustrated embodiment, the first directional control valve 118 is controlled by a second directional control valve 136. The second directional control valve 136 is a three-way, two-position directional control valve that is fluidly coupled to a pilot pressure actuator of the first directional control valve 118, to the supply line 108 downstream from the first check valve 114, and to the return line 110. In a first position, the second directional control valve 136 fluidly couples the pilot pressure actuator of the first directional control valve 118 to the return line 110, thereby enabling the first directional control valve 118 to move to the first position. In a second position, the second directional control valve 136 fluidly couples the supply line 108 to the pilot pressure actuator of the first directional control valve 118, thereby driving the first directional control valve 118 to the second position. The position of the second directional control valve 136 is controlled by a solenoid communicatively coupled to the controller. Accordingly, the controller is configured to control the position of the first directional control valve 118 via the second directional control valve 136.

The left wing blocking valve 54′ and the right wing blocking valve 54″ are fluidly coupled to a pilot drain line 129. Furthermore, a pilot pressure control valve 138 is fluidly coupled to the pilot line 128 and to the pilot drain line 129. The pilot pressure control valve 138 is configured to control the hydraulic fluid pressure within the pilot line 128 by controlling hydraulic fluid flow from the pilot line 128 to the pilot drain line 129. In the illustrated embodiment, the controller is communicatively coupled to the pilot pressure control valve 138, and the controller is configured to control the pilot pressure control valve 138 to control the fluid pressure within the pilot line 128. As illustrated, the pilot drain line 129 is fluidly coupled to the return line 110. In addition, a fourth check valve 140 is fluidly coupled to the pilot drain line 129 upstream of the blocking valves 54. The fourth check valve 140 is configured to enable hydraulic fluid to flow from the pilot pressure control valve 138 through the pilot drain line 129 and to block hydraulic fluid flow from the pilot drain line 129 to the pilot line 128.

When the hydromechanical linkage assembly 50 is in the transport mode, the left wing blocking valve 54′ and the right wing blocking valve 54″ are closed. When either of the left wing blocking valve 54′ or the right wing blocking valve 54″ is closed, the pilot drain line 129 is blocked, thereby blocking hydraulic fluid flow from the pilot line 128 to the return line 110. As a result, the hydraulic fluid pressure within the pilot line 128 may increase to the maximum pilot threshold pressure because the pilot pressure control valve 138 is unable to drain hydraulic fluid through the pilot drain line 129. Accordingly, the pressure reducing valve 124, which is controlled by the hydraulic fluid pressure within the pilot line 128, is driven to the fully open position. As such, when the left wing blocking valve 54′ and/or the right wing blocking valve 54″ are closed, fluid provided to valve assembly 104 (e.g., from the first hydraulic fluid input 100) directly controls extension of the wing fold cylinders. In certain embodiments, when the blocking valve(s) are closed, the controller controls the second directional control valve 136 to move to the first position to enable the first directional control valve 118 to move to the first position, thereby enabling the first hydraulic fluid input 100 to provide fluid to the valve assembly 104.

Conversely, when the hydromechanical linkage assembly 50 is in the operation mode, the left wing blocking valve 54′ and the right wing blocking valve 54″ are open. When the left wing blocking valve 54′ and the right wing blocking valve 54″ are open, hydraulic fluid from the pilot line 128 may drain through the pilot drain line 129, thereby enabling the pilot pressure control valve 138 to control the hydraulic fluid pressure within the pilot line 128. Because the hydraulic fluid pressure within the pilot line 128 controls the pressure reducing valve 124, the controller may control the pilot pressure control valve 138 to control the pressure reducing valve 124, thereby controlling the hydraulic fluid pressure within the cap ends of the wing fold cylinders. As such, when the left wing blocking valve 54′ and the right wing blocking valve 54″ are open, the controller controls the pilot pressure control valve 138 to control the hydraulic fluid pressure within the cap ends of the wing fold cylinders. Therefore, the controller controls the downforce applied by the wing fold cylinders. In certain embodiments, when the blocking valves are open, the controller also controls the second directional control valve 136 to move to the second position to drive the first directional control valve 118 to the second position, such that the supply pump 112 provides hydraulic fluid to the valve assembly 104. Furthermore, as previously discussed, the controller may control the downforce applied by the wing fold cylinders based on feedback from the sensors (e.g., position sensor(s), penetration depth sensor(s), etc.). In addition, in certain embodiments, pressure sensor(s) 142 fluidly coupled to the pilot line 128 may enable the controller to determine whether the hydromechanical linkage assembly 50 is in the transport or the operation mode based on sensor feedback.

The second hydraulic fluid input 102 is directly fluidly coupled to the rod ends of the left wing fold cylinders 36 and the right wing fold cylinders 38 via a second control line 144. Accordingly, to drive the wing fold cylinders to retract, the controller may control the second directional control valve 136 to move to the first position to enable the first directional control valve 118 to move to the first position, such that hydraulic fluid may drain through the first hydraulic fluid input 100. Hydraulic fluid from the second hydraulic fluid input 102 may then be provided to the rod ends of the wing fold cylinders to drive the wing fold cylinders to retract, regardless of the configuration of the blocking valves 54.

While the first directional control valve 118 is controlled by the second directional control valve 136 in the illustrated embodiment, in other embodiments, the second directional control valve may be omitted, and the controller may control the first directional control valve directly. Moreover, in certain embodiments, the tillage implement may include two hydraulic circuits, one for the left wing fold cylinders and one for the right wing fold cylinders, thereby enabling independent control of the left wing section and the right wing section of the tillage implement. In such embodiments, each hydraulic circuit may include one respective blocking valve.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112 (f). However, for any claims containing elements designated in any other manner, it is intended that such elements are not to be interpreted under 35 U.S.C. 112(f).

1. A wing force management system of an agricultural implement, comprising:
a hydromechanical linkage assembly configured to couple to a frame of the agricultural implement, wherein the hydromechanical linkage assembly comprises a blocking valve;
a driver coupled to the frame of the agricultural implement; and
a valve assembly configured to control a wing fold cylinder of the agricultural implement, wherein the wing fold cylinder is configured to drive a wing section of the frame to rotate relative to a center section of the frame, and the valve assembly is fluidly coupled to the blocking valve;
wherein the driver is configured to actuate the blocking valve in response to rotation of the wing section of the frame to control the valve assembly to adjust fluid pressure within the wing fold cylinder.

2. The wing force management system of claim 1, wherein the driver is configured to actuate the blocking valve in response to rotation of the wing section from a folded transport position toward an unfolded working position.

3. The wing force management system of claim 1, wherein the hydromechanical linkage assembly comprises a link, and the driver is configured to engage the link to actuate the blocking valve.

4. The wing force management system of claim 1, wherein the driver is configured to actuate the blocking valve while the wing section is positioned at an angle between 0 and 45 degrees relative to a horizontal plane.

5. The wing force management system of claim 1, wherein the valve assembly is configured to control downforce applied by the wing fold cylinder while the blocking valve is open.

6. The wing force management system of claim 5, comprising a controller comprising a memory and a processor, wherein the controller is configured to control the valve assembly to control the downforce applied by the wing fold cylinder.

7. The wing force management system of claim 6, comprising a penetration depth sensor communicatively coupled to the controller, wherein the penetration depth sensor is configured to output a signal indicative of a penetration depth of one or more ground-engaging tools of the agricultural implement, and the controller is configured to control the valve assembly to control the downforce applied by the wing fold cylinder based on sensor feedback from the penetration depth sensor.

8. An agricultural implement, comprising:
a frame comprising a center section and a wing section;
one or more ground-engaging tools coupled to the frame;
a wing fold cylinder coupled to the center section and to the wing section, wherein the wing fold cylinder is configured to control an angular position of the wing section relative to the center section;
a hydraulic circuit comprising a valve assembly fluidly coupled to the wing fold cylinder, wherein the valve assembly is configured to control the wing fold cylinder;
a hydromechanical linkage assembly coupled to the frame, wherein the hydromechanical linkage assembly comprises a blocking valve;
a driver coupled to the frame;
wherein the driver is configured to actuate the blocking valve in response to rotation of the wing section to control the valve assembly to adjust fluid pressure within the wing fold cylinder.

9. The agricultural implement of claim 8, wherein the hydromechanical linkage assembly comprises a link, and the driver is configured to engage the link to actuate the blocking valve.

10. The agricultural implement of claim 9, wherein the driver is configured to engage the link to actuate the blocking valve while the wing section is positioned at an angle between 0 and 45 degrees relative to a horizontal plane.

11. The agricultural implement of claim 8, wherein the valve assembly is configured to control downforce applied by the wing fold cylinder while the blocking valve is open.

12. The agricultural implement of claim 11, comprising a controller comprising a memory and a processor, wherein the controller is configured to control the valve assembly to control the downforce applied by the wing fold cylinder.

13. The agricultural implement of claim 12, comprising a penetration depth sensor communicatively coupled to the controller, wherein the penetration depth sensor is configured to output a signal indicative of a penetration depth of the one or more ground-engaging tools, and the controller is configured to control the valve assembly to control the downforce applied by the wing force cylinder to adjust the penetration depth of the one or more ground-engaging tools.

14. The agricultural implement of claim 8, comprising:
a second wing section of the frame;
a second wing fold cylinder coupled to the center section and to the second wing section, wherein the second wing fold cylinder is configured to control an angular position of the second wing section relative to the center section;
a second blocking valve of the hydromechanical linkage assembly; and
a second driver coupled to the frame, wherein the second driver is configured to actuate the second blocking valve in response to rotation of the second wing section to control the valve assembly to adjust fluid pressure within the second wing fold cylinder.

15. A hydraulic circuit of an agricultural implement, comprising:
a valve assembly comprising:
a pressure reducing valve configured to control downforce applied by a wing fold cylinder of the agricultural implement, wherein the wing fold cylinder is configured to drive a wing section of a frame of the agricultural implement to rotate relative to a center section of the frame of the agricultural implement;
a pilot line configured to control the pressure reducing valve; and
a blocking valve configured to control hydraulic fluid in the pilot line; and
a driver coupled to the frame of the agricultural implement, wherein the driver is configured to actuate the blocking valve in response to rotation of the wing section to control the valve assembly to adjust fluid pressure within the wing fold cylinder.

16. The hydraulic circuit of claim 15, comprising:
a first hydraulic fluid input configured to fluidly couple to a cap end of the wing fold cylinder of the agricultural implement via the valve assembly, wherein the first hydraulic fluid input is configured to supply hydraulic fluid to the valve assembly to control extension of the wing fold cylinder; and
a second hydraulic fluid input configured to directly fluidly couple to a rod end of the wing fold cylinder of the agricultural implement, wherein the second hydraulic fluid input is configured to supply the hydraulic fluid to the rod end of the wing fold cylinder to control retraction of the wing fold cylinder

17. The hydraulic circuit of claim 15, comprising:
a supply line configured to provide the hydraulic fluid from a supply pump to the valve assembly; and
a return line configured to provide the hydraulic fluid from the valve assembly to a return.

18. The hydraulic circuit of claim 17, comprising a pilot pressure control valve fluidly coupled to the pilot line and to a pilot drain line, wherein the pilot drain line is fluidly coupled to the return line, the pilot pressure control valve is configured to control hydraulic fluid flow from the pilot line to the pilot drain line, and the blocking valve is fluidly coupled to the pilot drain line to control hydraulic fluid pressure in the pilot line.

19. The hydraulic circuit of claim 18, wherein the agricultural implement comprises a controller comprising a memory and a processor, the controller is configured to control the pilot pressure control valve to control the pressure reducing valve to control the hydraulic fluid pressure within the wing fold cylinder to control the downforce applied by the wing fold cylinder while the blocking valve is open.

20. The hydraulic circuit of claim 15, wherein the hydraulic fluid provided to the valve assembly directly controls the extension of the wing fold cylinder of the agricultural implement while the blocking valve is closed.
